(19) United States
(12) Patent Application Publication
(10) Pub. No.: US 2025/0105778 A1
(43) Pub. Date: Mar. 27, 2025

(54) Single Axis Solar Collector Array

(71) Applicant: Exowatt, Inc., Miami, FL (US)

(72) Inventors: Hannan PARVIZIAN, Miami, FL (US); Sushrut BAPAT, Miami, FL (US)

(21) Appl. No.: 18/899,969

(22) Filed: Sep. 27, 2024

Related U.S. Application Data
(60) Provisional application No. 63/585,803, filed on Sep. 27, 2023.

(51) Int. Cl. H02S 20/32; F24S 30/40

(52) U.S. Cl. CPC H02S 20/32; F24S 30/40

(57) ABSTRACT

A rugged Fresnel lens panel support structure changes the azimuthal orientation of the panels in a single degree of freedom using a linear actuator to track the changing position of the sun.

### CROSS-REFERENCE TO RELATED APPLICATIONS

This application claims benefit of U.S. provisional application No. 63/585,803 filed Sep. 27, 2023; and U.S. provisional application No. 63/692,663 filed Sep. 9, 2024, each of which is incorporated herein by reference.

### FIELD

The technology herein relates to collection of thermal energy, and to solar collectors that collect solar energy and produce electrical and thermal output power. More particularly, the technology relates to a thermal collector providing a simple and rugged mechanical structure that moves the collectors to track the position of the sun. Still more specifically, the technology relates to such solar or thermal collectors that use single axis tracking to track the sun's position.

### BACKGROUND & SUMMARY

We all know the sun rises in the east and sets in the west. We also know the times the sun rises and sets are based on the time of year and our location on the earth's surface. For example, days grow shorter in the northern hemisphere as the winter solstice approaches and they grow longer as we approach the summer solstice. Meanwhile, in the southern hemisphere it is just the opposite—as the days are growing longer in the northern hemisphere they are growing shorter in the southern hemisphere and vice versa. There are always twelve hours of daytime and twelve hours of night-time at the equator, except for two minor effects that increase daytime by about eight minutes. Most of us probably vaguely know these changes have to do with the tilt of the earth relative to the sun which is responsible for changing seasons in the northern and southern hemispheres.

Yet, the path the sun takes in the sky is actually a bit more complicated. For example, the sun takes an arc across the southern sky from locations north of the equator and takes an arc across the northern sky from locations south of the equator. The exact angle and arc depends on the latitude of the observer and the time of year.

Not only is the earth tilted on its axis relative to the sun, but the earth is also orbiting the sun in a path that is elliptical rather than circular. Orbiting in an ellipse doesn't just mean that the Earth is closer to or farther from the Sun at certain points in its orbit. It also—by Kepler's second law—means that when the Earth is close to the Sun (perihelion), it possesses a faster orbital speed, and when the Earth is far from the Sun (aphelion), it possess a slower orbital speed. The effects together mean that during the course of a year, if you took the sun's position every day at the same time you would see that the sun traces an analemma or figure eight in the sky. We can intuitively understand this by remembering that the angle of light during the winter seems to be different (the sun's arc is lower in the sky in the northern hemisphere and higher in the sky in the southern hemisphere) than the angle of light during the summer.

Meanwhile, the Earth doesn't rotate once on its axis every 24 hours. Instead, the Earth makes a full 360° rotation in just 23 hours and 56 minutes. A day takes 24 hours because it takes those extra 4 minutes to “catch up” to the amount of distance the Earth has traveled in its orbit around the Sun. During an average day, when the Earth moves at its average speed around the Sun, 24 hours is just right. But when the Earth moves more slowly (near aphelion), 24 hours is too long for the Sun to return to its same position, and so the Sun appears to shift more slowly than average. Similarly, when the Earth moves more quickly (near perihelion), 24 hours isn't quite long enough for the Sun to come back to where it started, and so it shifts more quickly than average. Thus, the sun's path is influenced by its position relative to the celestial equator and the ecliptic, both of which change with the earth's orbit about the sun. All this makes for a complex but very predictable path the sun will take across the sky on any given day of the year at any given location on the earth's surface but which will change from one day to the next. See e.g., Siegel, “This Is How The Sun Moves In The Sky Throughout The Year” (Forbes 2019), forbes.com/sites/startswithabang/2019/01/01/this-is-how-the-sun-moves-in-the-sky-throughout-the-year/?sh=48c77e7a7303.

Thus, for most latitudinal positions on the earth's surface, the sun will track (relative to the earth) a slightly different path across the sky from one day to the next (whereas the path it traces on a given day of the year such as May 21 will be nearly although not exactly the same as the path it traces on that same day May 21 the following year or the path it traced on that same day May 21 the previous year), Meanwhile, on any given day, the sun will essentially constantly change both its elevation and its azimuth from one moment to the next. Anyone can notice this by watching changing shadows cast in bright sunlight, or watching the sun as it rises over the horizon or sets into the horizon.

To maximize efficient solar collection, a solar collector should therefore optimally be aimed directly at the sun in order to maximize the energy it collects. This is why solar collectors are typically designed to track the sun's position in two axes. Ideally, the solar collector should track in two degrees of freedom (azimuth and elevation) so it can always aim precisely at the sun's position. Two different actuators and associated drives (one for the azimuthal rotation (“left to right”) and another for the elevational rotation (“up and down”), in a spherical reference frame and associated spherical coordinates) can be controlled independently to rotate the solar collector to the precise orientation it needs to be in to aim at the sun at all times and thus exactly control the sun's angle of incidence on the collector's optical surfaces. A computer including a real time clock/calendar can automatically control the actuators/drives of the collector so the collector frequently updates its orientation as the sun moves across the sky.

While the above theory of automatic solar tracking is straightforward, a challenge is thus to construct actuators/drives and support frames for solar collectors that are rugged, reliable and inexpensive. This problem gets worse as the size and number of solar collectors increase because of increased weight, wind resistance and other factors.

Specifically, dual axis tracking as described above—which is known to provide more accurate tracking—can substantially increase complexity and cost. A simpler, rugged single axis tracking design that in some embodiments takes off-axis incidence of the sun's rays into account and at least partially corrects for it would be highly useful and desirable.

### BRIEF DESCRIPTION OF THE DRAWINGS

FIG. 1 shows an example single axis solar collector array.

FIG. 2 shows a top down perspective view of the example array.

FIG. 3 shows a top down birds eye view.

FIG. 4 shows a view of the bottom of the array from the ground or other surface.

FIG. 5 shows a view from the right.

FIG. 6 shows a view from the left.

FIG. 7 shows a view from the front.

FIG. 8 shows a view from the back.

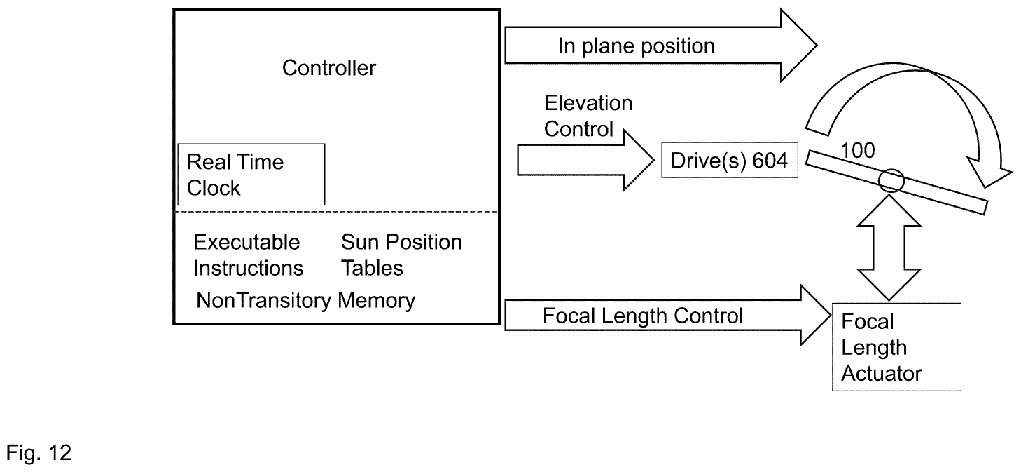

FIG. 9 shows a perspective view from the bottom.

FIGS. 10A, 10B, 10C show an example south pitched signal axis tracking system.

FIG. 11 shows an example single axis Fresnel lens tracker.

FIG. 12 shows an example electronic controller.

FIGS. 13A, 13B, 13C are together a flip chart animation of Fresnel lens elevation control.

FIGS. 14A, 14B, 14C are together a flip chart animation of Fresnel lens focal length adjustment.

FIG. 15 shows single axis drive details.

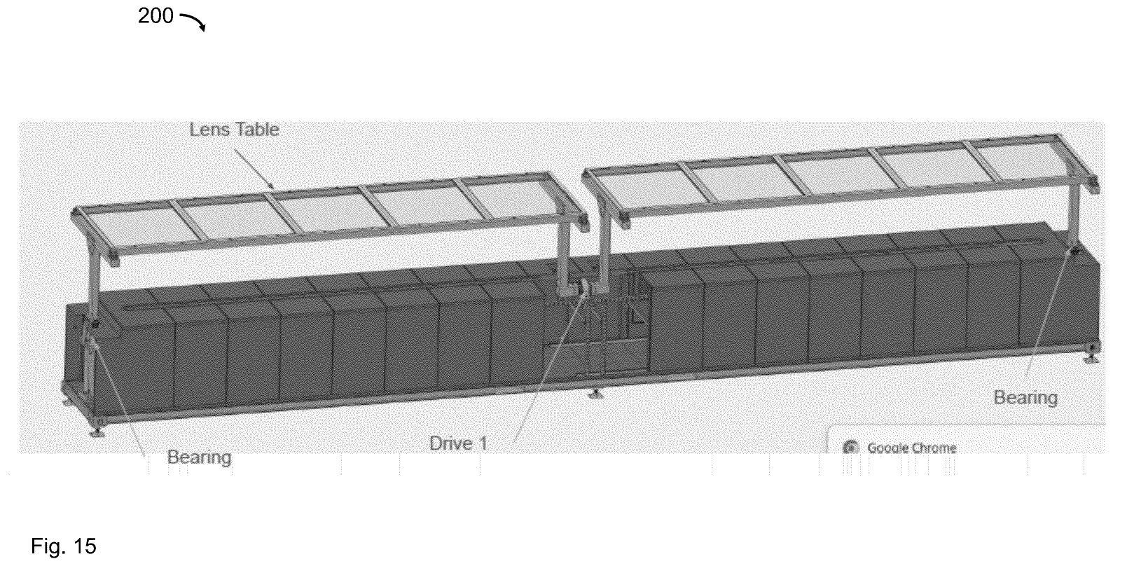

FIG. 16 shows additional focal length adjustment and in-plane axial adjustment.

FIG. 17 shows a multi-frame drive ganging.

FIG. 18 shows an example bearing detail.

FIG. 19 shows a side view of a tracking drive.

### DETAILED DESCRIPTION OF NON-LIMITING EMBODIMENTS

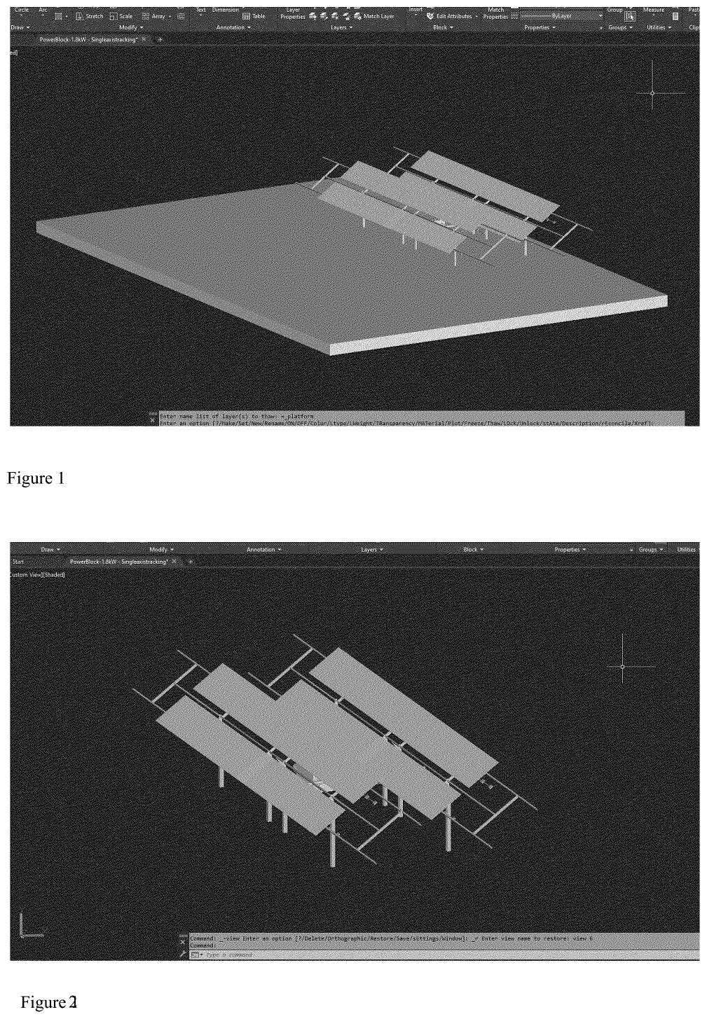

FIG. 1 shows an example top perspective view of a solar collector array moveable in a single axis to follow the direction of the sun. As shown in the drawing, the array includes plural planer collectors which in one embodiment may comprise arrays of planer Fresnel lenses that each receive solar rays from the sun and diffract or bend (concentrate) the solar rays to a thermal and/or optical collection device. The Fresnel lens structures can be made of glass, polycarbonate plastic, acrylic plastic or any other suitable material. See e.g., Xie et al, “Concentrated solar energy applications using Fresnel lenses: A review,” Renewable and Sustainable Energy Review Volume 15, Issue 6, August 2011, Pages 2588-2606, doi.org/10.1016/j.rser.2011.03.031. In the example shown, the Fresnel lens arrays are each long rectangular panels but they can be of any shape, size and dimensions. One example of a Fresnel lens in a frame may be seen in U.S. patent application Ser. No. 29/961,987 filed Sep. 9, 2024.

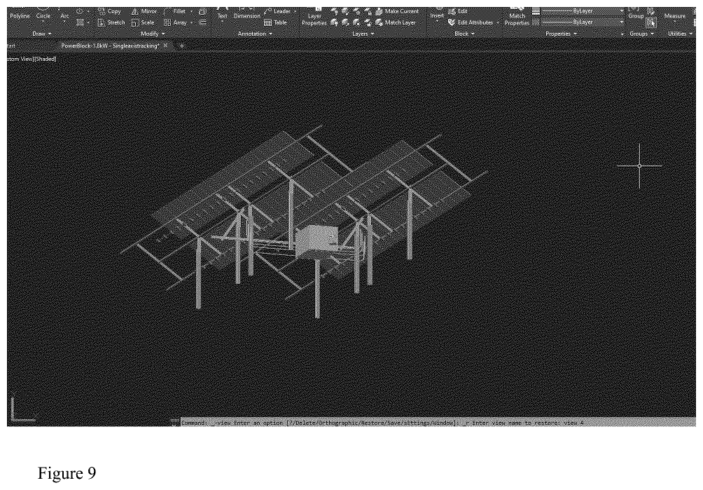

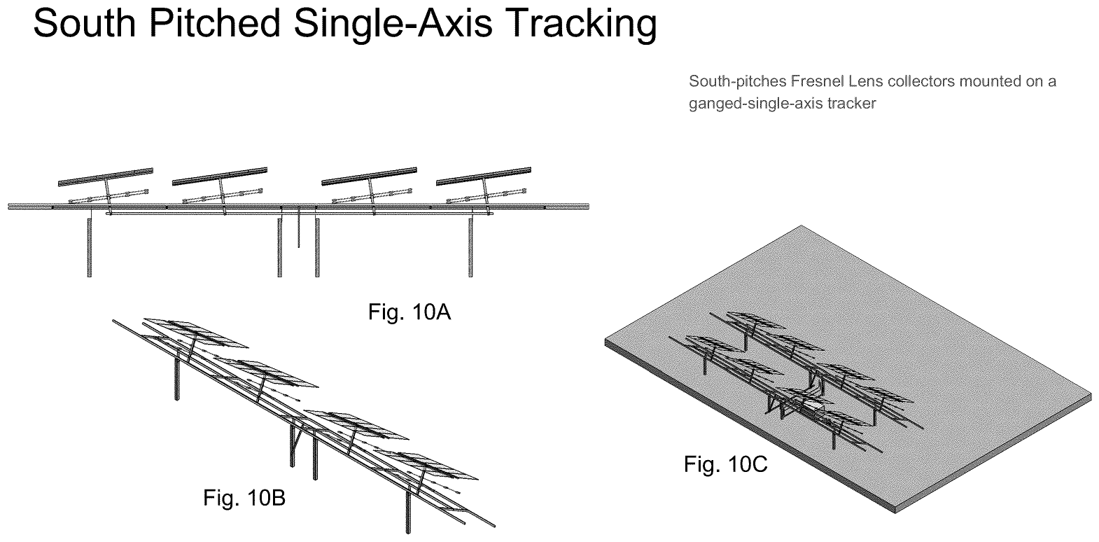

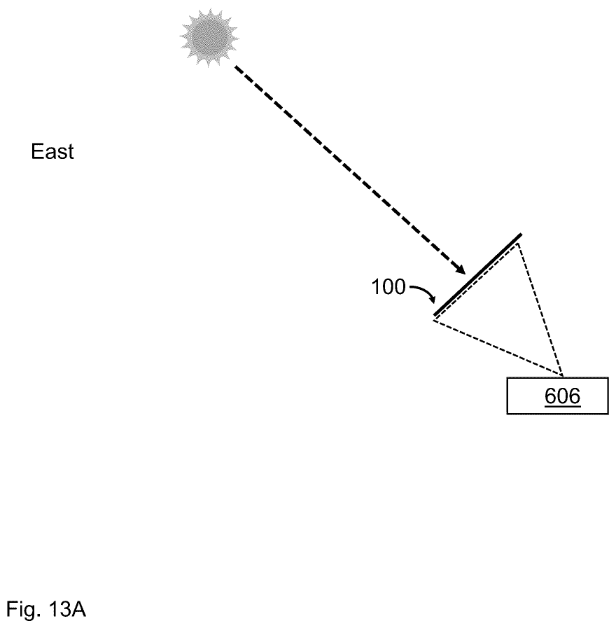

In the example shown, the Fresnel lens panels are mounted to tubular frames that are supported by vertical upright posts that may for example extend from the ground or other surface or other structure (see embodiments discussed below). As can be seen in FIGS. 5 and 6, the tubular frames and thus the Fresnel lens panels may be supported by the upright posts. In particular, as can be seen from FIG. 9, each frame may comprise a rectangular open frame structure including a plurality of cylindrical rodlike elements (which may be tubular or solid) extending beyond the dimension of the Fresnel lens panels the frame structure supports. As many such cylindrical rodlike elements may be used as needed to adequately support the Fresnel lens panels. Crosspiece rodlike structures may be used to hold the frame structure together and strengthen it.

FIGS. 5 and 6 further show that the frame structures are pivotally mounted to the vertical posts so their orientations may be changed in one dimension (e.g., elevation) by rotating the frame structures relative to the posts. In particular, angled guides attached to the frame structures are mechanically coupled to a horizontal position element that can move back and forth under the effect of a linear actuator. As the horizontal position element moves, it causes the frame structures and thus the Fresnel lenses to change their elevational orientation relative to the horizon. The structure shown is ganged so several such angled guides may be connected to a common horizontal position element and move together with longitudinal movement of the horizontal position element. The horizontal position element retains the frame structures and thus the Fresnel arrays in a current position and then can change the orientation of the frame structures (i.e., pivot them by a variable amount about pivot points attaching them to the upright posts) based on movement of the actuator. As shown in FIG. 9, a single angled guide can be used to change the orientation of a very long frame structure, and several different frame structures can thus be moved together with back and forth motion of the horizontal position element by a corresponding linear actuator. Alternatively, the frame structures can be divided up and supported independently, but ganged together to a single drive can move all of the frame structures together.

In one embodiment, the vertical posts are installed in a suitable direction (compass bearing) based on the latitude of collector installation. Then, the linear actuator sets the position of the horizontal position element based on the time of day and day of the year (as programmed into a computer or controller based on the latitude) to track the sun's position as it moves in the sky. As discussed above, the sun's position at a given time of day will trace a figure eight in the sky over the course of a year, and the controller can take this into account in controlling the actuator to position of the horizontal position element and thus the orientations of the solar collector panels. In one embodiment, the collector array is installed in an appropriate orientation relative to the earth's surface so the panels can track the sun's position as the sun moves from east to west by rotating about a single axis. In this case, only the elevational orientation of the panels tracks the sun's position, which means that the sun's angle of incidence will rarely if ever be perfectly normal to the surface of any given Fresnel lens panel. Nevertheless, such single-axis tracking substantially improves efficiency of the Fresnel lens panels focusing onto corresponding absorber surfaces over what would be provided if the lens panels did not automatically track but instead remained in fixed positions (as one often sees on roofs and in solar panel fields).

The controller is also able to position the Fresnel lens array in a vertical or other resting orientation during the night. In some embodiments, the controller may include a wind speed and direction detector (or receive this information from a remote weather monitoring source over a network) to position the array in a particular orientation that reduces likelihood of wind damage (e.g., by orienting the panels to minimize cross-sectional profile in the wind direction).

In one embodiment, the system is calibrated based on the particular installation orientation of the solar collection array relative to the surface of the earth so an electronic controller can perform a lookup in a table (the angular contents of which depends on latitude) based on (a) time of day and (b) day of year and (c) calibration parameters, to position the horizontal positioning actuators so the solar panels are aimed at and follow the current position of the sun. The controller can control the actuator to change its position once every few minutes to track the sun's changing position. For example, the lookup table may contain actuator positions that correlate with spherical or polar coordinates specifying the sun's angular position in the sky at the installation's particular latitude based on time of day and day of the year. The controller may include a real time clock/calendar that indexes the lookup table to determine the correct linear, slew and/or rotational position of the actuators. In one embodiment, a linear position sensor or encoder may be used to sense position of the actuator (and/or orientations of the solar panels or associated carrying frame structures) to ensure accurate positioning in a closed loop system.

The system as described provides efficient solar tracking across a range of medium latitudes. For installation in higher or lower latitudes, one embodiment enables manual setting of non-tracking rotational orientation axes of the panels depending on the season of year. For example, three different fixed orientation axis settings (summer, winter and spring/fall) might be used in higher or lower latitudes to increase tracking accuracy of the sun's seasonally-changing arc across the sky.

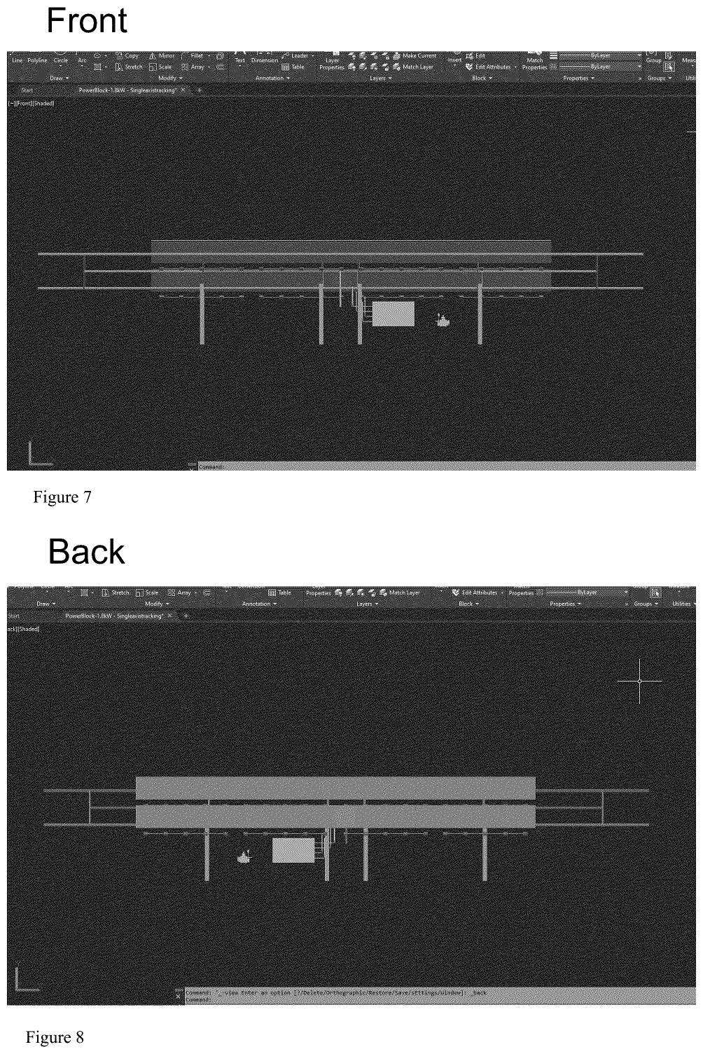

As shown in FIGS. 4 & 5, the underside or other portion(s) of the frame structure and/or the Fresnel panels may further provide a suspended array of solar collectors. Each solar collector in the array is positioned at the focal point of at least one corresponding Fresnel solar collection panel. Thus, as the solar panels change their (common) orientation, the solar collectors similarly change their (common) orientation so the solar energy refracted by each Fresnel lenses remains focused on a corresponding collector. In one embodiment, the solar collections may comprise for example thermal collectors that collect thermal energy and provide such collected thermal energy to a thermal load such as a thermal storage device, a thermal engine, or other arrangement that uses and/or stores thermal energy. In other example embodiments, the solar collectors could comprise solar light collectors or collectors that collect both thermal energy and light. In another embodiment, the solar collectors can be stationary and have absorber surfaces that are dimensioned and shaped so that untracked movement of the sun relative to the Fresnel lens panels ensure the focused light remains on the absorber surfaces. For example, the absorber surfaces may each extend in a dimension along the rotational axis of the panels so that the sun's positional changes relative to the panels that cannot be tracked by rotation of the panels about their rotational axis will cause the panels' focal points or lines to trace (e.g., one-dimensional) paths on the respective absorber surfaces that remain on the absorber surfaces as the sun's incidence angle(s) change relative to the panels.

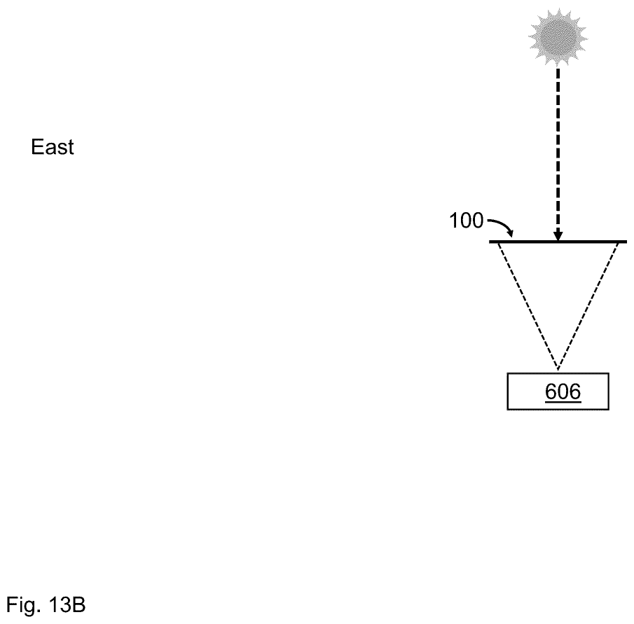

FIG. 10A, 10B and 10C show different views of an example collection system comprising south-pitched Fresnel lens collector panels mounted on a ganged single-axis tracker.

### High Natural Frequency Tracker Embodiment

Further example embodiments provide a high natural frequency tracker solution for Fresnel lens applications. Example embodiments track a series of point-focus Fresnel Lenses for sequential heat collection while maintaining high-natural frequency for high-wind loads.

A multi-drive or a single-drive balanced design provides a straightforward way of tracking Fresnel lenses for such environmental demands. Other drives are used for improving the tracker effectiveness. Effectiveness is defined as the ratio of concentrated energy delivered through an aperture to the energy provided by the sun on the tracker.

Non-limiting advances include improved wind stability, improved optical effectiveness, a unique concept around utilizing Fresnel lens and single axis tracking, and harvesting energy with active focal point tracking.

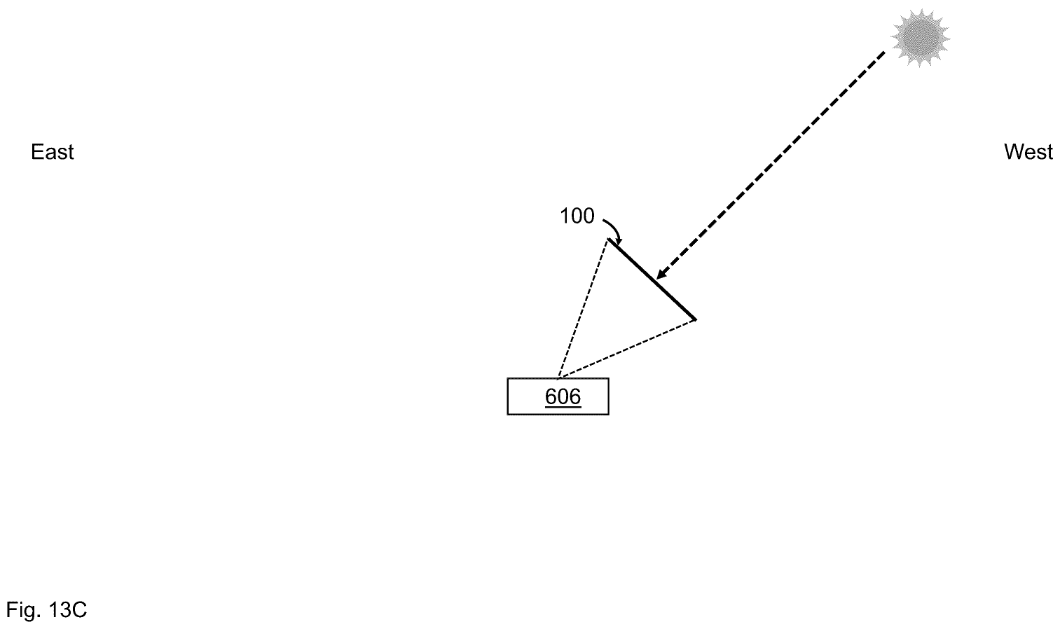

FIG. 11 shows an example top perspective view of a solar collector array moveable in a single axis to follow the direction of the sun. As shown in the drawing, the array includes plural planer collectors which in one embodiment may comprise arrays of planer Fresnel lenses that each receive solar rays from the sun and diffract or bend (concentrate) the solar rays to a thermal and/or optical collection device. The Fresnel len structures can be made of glass, polycarbonate plastic, acrylic plastic or any other suitable material. See e.g., Xie et al, “Concentrated solar energy applications using Fresnel lenses: A review,” Renewable and Sustainable Energy Review Volume 15, Issue 6, August 2011, Pages 2588-2606, doi.org/10.1016/j.rser.2011.03.031. In the example shown the Fresnel lens arrays are each long rectangular panels but they can be of any shape, size and dimensions.

In the example shown, the Fresnel lens panels are mounted to upright posts that may extend upwards from a support structure.

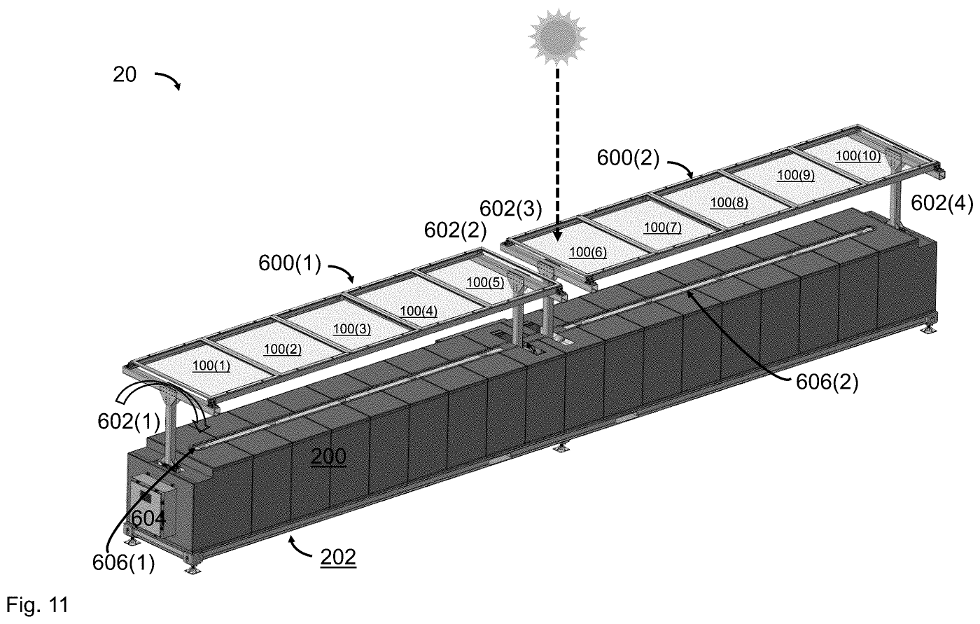

The elevational orientations of the frame structures mounted to the vertical posts may be changed in one dimension (e.g., elevation) by rotating the frame structures. As the angle of the upright posts changes relative to the horizon, the frame structures and thus the Fresnel lenses change their elevational orientation relative to the horizon. The structure shown is ganged so several such uprights may be connected or ganged to rotate together (see FIG. 7) by a common drive. The upright posts and associated drive or drives connected thereto thus retain the frame structures and thus the Fresnel arrays in a current position and can change the orientation of the frame structures based on movement of a drive(s) or actuator(s). As shown, a single drive can be used to change the orientation of a linear frame structure, and two or more different frame structures can be rotated together.

The single drive may be a slewing drive, a rotational drive or another type of drive. Slewing drives are made up of a slewing ring, a screw worm, bearings, a housing, and other components. One slew drive embodiment uses a horizontal screw and a perpendicular gear to create radial torque. The screw's axial movement transfers torque to the gear, and the speed ratio is determined by the number of threads on the screw and the number of gears.

In one embodiment, the upright posts and associated support structure are installed in a suitable direction (compass bearing) based on the latitude of collector installation. Then, a controller operating the drive sets the rotational angle of the uprights based on the time of day and day of the year (as programmed into a computer or controller based on the latitude) to track the sun's position as it moves in the sky. As discussed above, the sun's position at a given time of day will trace a figure eight in the sky over the course of a year, and the controller can take this into account in controlling the drive to set elevational orientations of the solar collector panels. In one embodiment, the collector array is installed so the panels can automatically track the sun's position as the sun moves from east to west. The controller is also able to position the Fresnel lens array in a vertical or other rest orientation during the night. In some embodiments, the controller may include a wind speed and direction detector (or receive this information from a remote weather monitoring source over a network) to position the array in an orientation that reduces likelihood of wind damage based on wind direction.

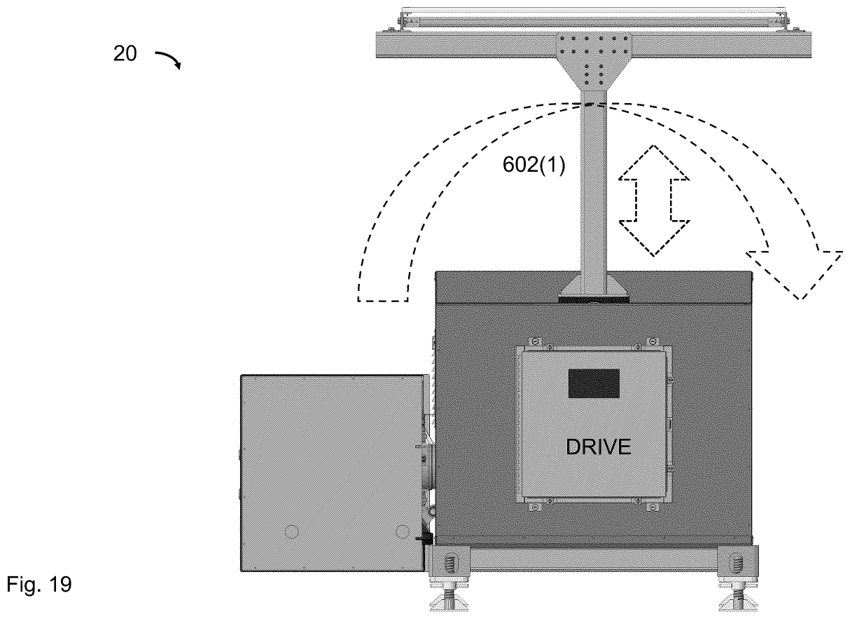

In the embodiment shown in FIG. 11, solar collection platform (SCP) 20 includes an elongated housing 200 supported by a ground frame 202. The elongated housing 200 supports a linear array of Fresnel lenses 100. The linear array of Fresnel lenses 100 are encased in and supported by a movable frame(s) 600. In example embodiments, the movable frame(s) 600 is/are rotatable about the longitudinal axis of the elongated housing 200. A drive(s) 604 is provided to rotate the movable frame(s) 600 about that longitudinal axis. See FIG. 19.

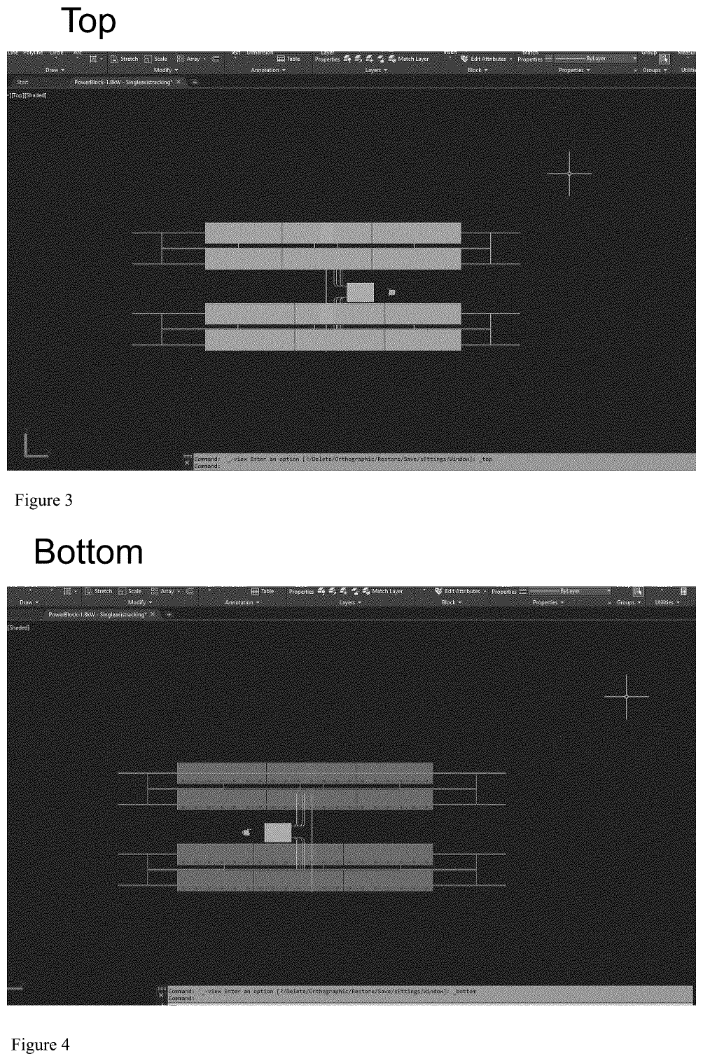

The drive(s) 604 is/are controlled by an electronic controller shown in FIG. 2 comprising a CPU, a processor and/or an electronic circuit including a real time clock. The controller computes the position of the sun in the sky based on time of day, day of year and geolocation of the SCP. The controller operates the drive(s) 604 to continually change the orientation angle of the Fresnel lenses 100 to track the sun's position as it moves in the sky, in order to collect and focus solar energy from the sun onto absorber structures 606 disposed on or accessible through a top surface of elongated housing 200.

In one embodiment, the system is calibrated based on the particular installation orientation of the solar collection array relative to the surface of the earth so an electronic controller can perform a lookup in a table (the angular contents of which depends on latitude) based on (a) time of day and (b) day of year, to position the horizontal positioning actuators so the solar panels are aimed at the current position of the sun. The controller can control the drive to change its position once every few minutes to track the sun's changing elevational position. For example, the lookup table may contain elevational positions that correlate with spherical or polar coordinates specifying the sun's angular position in the sky at the installation's particular latitude based on time of day and day of the year. The controller may thus include a real time clock/calendar that indexes the lookup table to determine the correct elevational position of the frame and Fresnel lenses for the particular time/date. In one embodiment, a linear position sensor or encoder may be used to sense elevational orientations of the solar panels or associated carrying frame structures to ensure accurate positioning.

The system as described provides efficient solar tracking across a range of medium latitudes. For installation in higher or lower latitudes, one embodiment enables manual setting of the rotational orientations of the panels depending on the season of year. For example, three orientation settings (summer, winter and spring/fall) might be used in higher or lower latitudes to increase tracking accuracy of the sun's seasonally-changing arc across the sky.

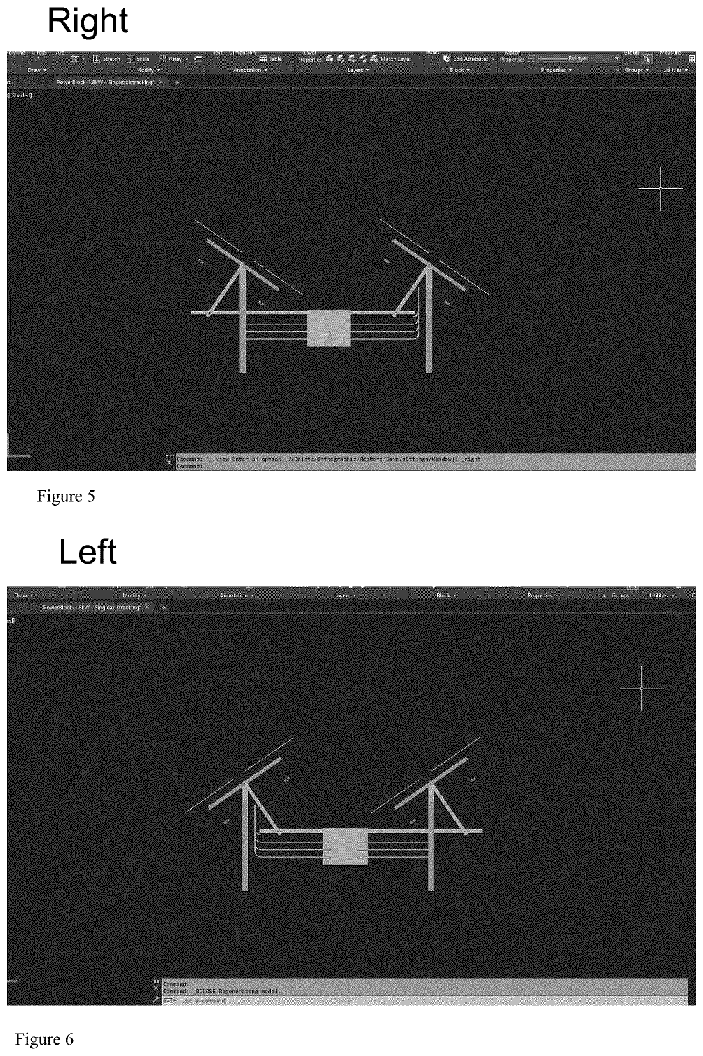

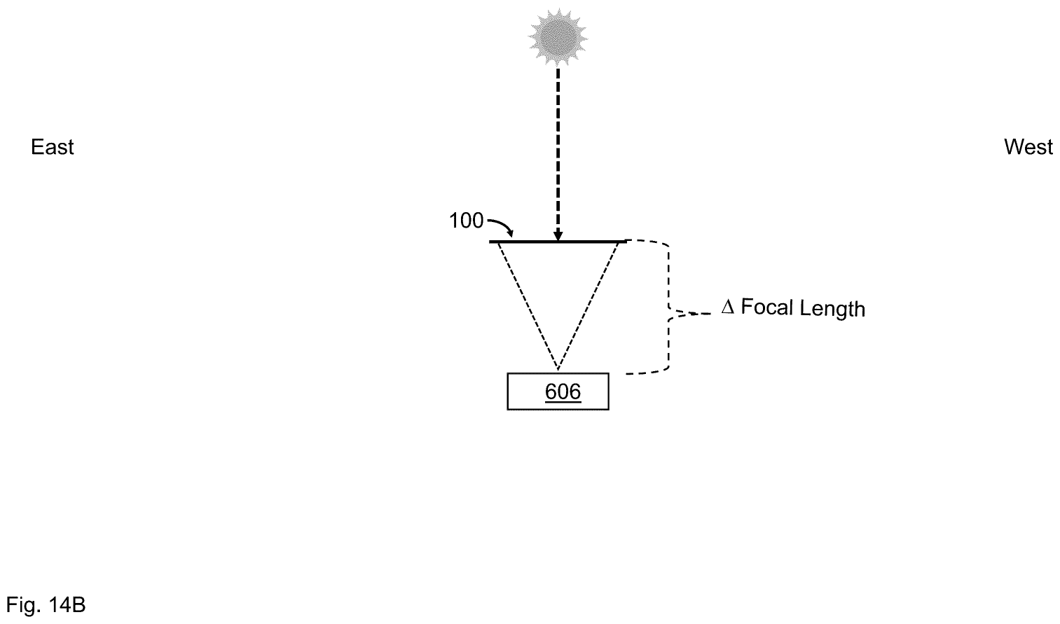

FIGS. 13A, 13B and 13C are together a flip chart animation showing example rotation by drive(s) 604 of the Fresnel lens panel 100 as the sun's position changes from morning (FIG. 3A) to midday (FIG. 3B) to afternoon (FIG. 3C). In example embodiments, the electronic controller controls the drive(s) 604 to maintain the surfaces of the Fresnel lenses 100 to be approximately perpendicular to the sun's elevational position as the sun moves in the sky. In these embodiments, to keep the system rugged and simpler, the drive(s) 604 rotates the Fresnel lens frame(s) 600 about only one axis to track the sun's changing elevation in the sky. Thus, the drive(s) 604 may rotate through a range of elevation angles from dawn to dusk, presenting the flat surfaces of the Fresnel lenses 100 to normal illumination by the sun such that the Fresnel lenses 100 collect and focus the sun's rays onto absorber structures 606.

### Automatic Focal Length Adjustment

A challenge of a single axis tracking system is that the sun constantly changes in both azimuth and elevation as it traces a path through the sky whereas the single axis tracking system can typically change only in elevation angle. Therefore, in a general case, the direction of the sun's rays on any given day and time will not be perfectly normal to the Fresnel surface of single-axis tracking Fresnel lenses 100 but will instead be incident off axis to some degree. This off axis incidence deviation tends to worsen at the beginning and the end of each day, resulting in defocusing of the concentrated solar energy incident on the absorbers and decreasing efficiency. In particular, a focal length change is caused by the change of refraction condition inside the prisms of the Fresnel lenses 100. See Liang et al, Concentrating behavior of elastic Fresnel lens solar concentrator in tensile deformation caused zoom, Renewable Energy Volume 209 June 2023, Pages 471-480,//doi.org/10.1016/j.renene.2023.04.013:

Research shows that the daily working hours of a single-axis tracking Fresnel lens solar concentrator are quite short, which leads to a low return on investment. The short daily working hours of a single-axis tracking Fresnel lens are caused by Fresnel lens focal length change during light off-normally incidence. The off-normal incidence will inevitably occur in the morning and afternoon, and the focal length will change shorter. As a result, the stationary installed receiver cannot intercept the converged sunlight totally. Consequently, that focal length change might be a factor hindering the large-scale application of Fresnel lenses in solar concentration.

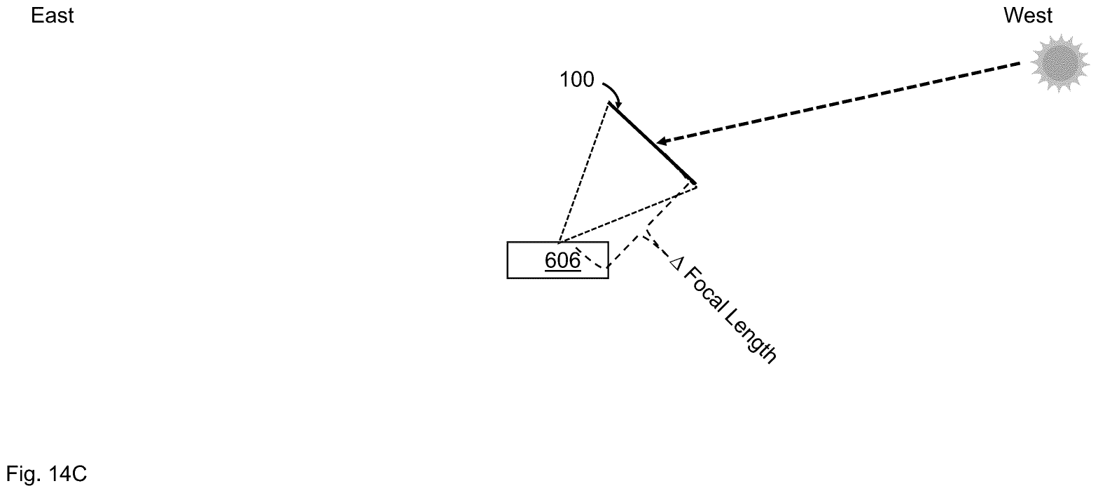

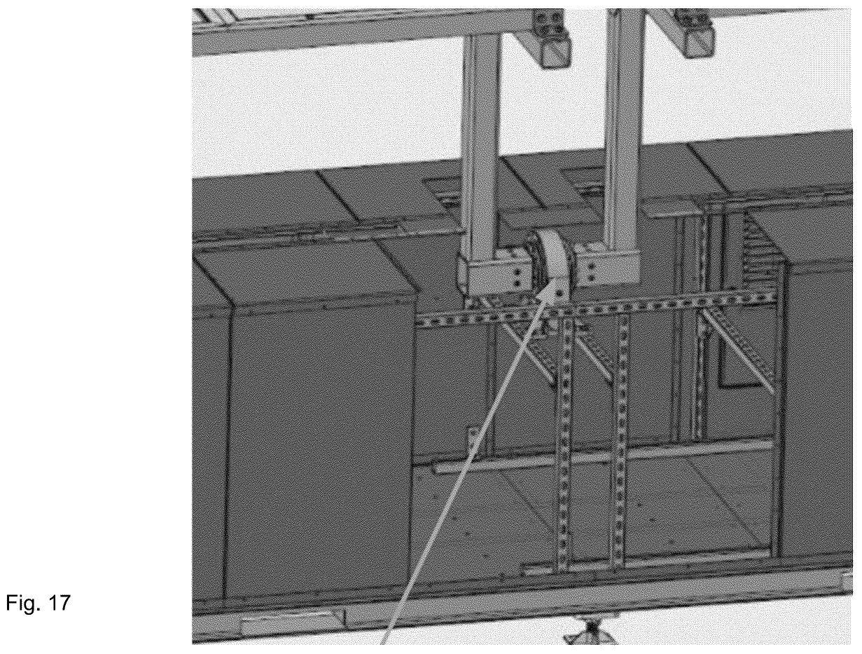

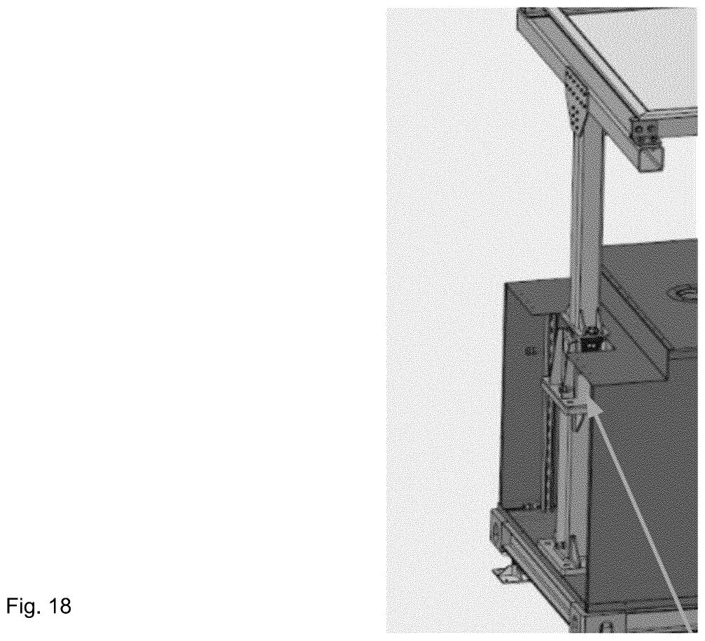

To solve the above challenge, example embodiments include an additional, automatic focal length control. The automatic or manual focal length control (which may also be in some way synchronized to the time of day, day of the year, and geolocation of the SCP) controls a variable distance between the Fresnel lens 100 and its absorber 606 in order to provide better focus of concentrated rays onto the absorber 606 for off-axis sun positions the Fresnel lens is unable to perfectly track. FIGS. 14A, 14B, 14C show an example flip chart animation of focal length adjustment applied in combination with a Fresnel lens 100 orientation adjustment to account for off-axis solar rays. FIGS. 17 and 18 meanwhile show further actuators and/or adjustments that accomplish this focal length adjustment. In one embodiment, this is accomplished by selectively and controllably raising/lowering and/or telescoping the upright posts to increase or decrease the distance between the Fresnel lenses 100 and associated absorbers on which the lenses are focusing solar energy depending on the (average and/or instantaneous) azimuthal incidence angle the suns rays make with respect to the Fresnel lenses.

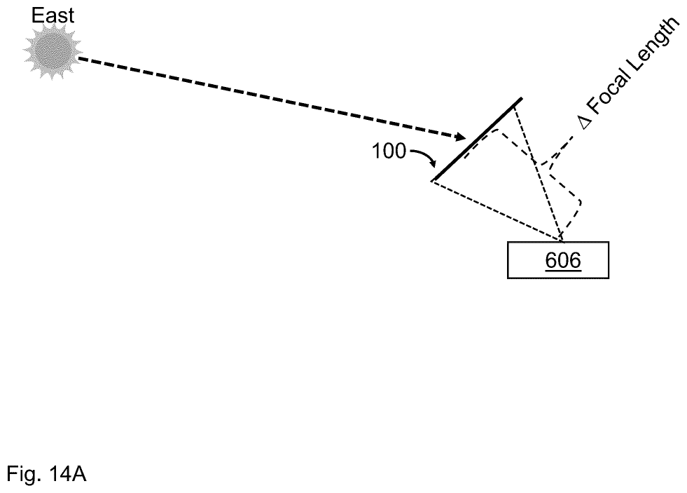

In one embodiment, the variable focal length adjustment need be made only infrequently (e.g., once a month) to change the focal length for that month in order to accommodate the off-axis incidence angle of the sun during that month. In such embodiment, a manual mechanical adjustment could be used to make such infrequent adjustments, or as shown in FIG. 12, an automatic actuator can be used to make the variable focal length adjustments. Or in one embodiment, the FIG. 12 controller could generate an alert or instructions on a display screen that inform an operator to make a mechanical adjustment, and the controller could then sense results to determine if the adjustment was correct or more adjustment is needed.

### Horizontal Longidinal Adjustment/In-Plane Motion

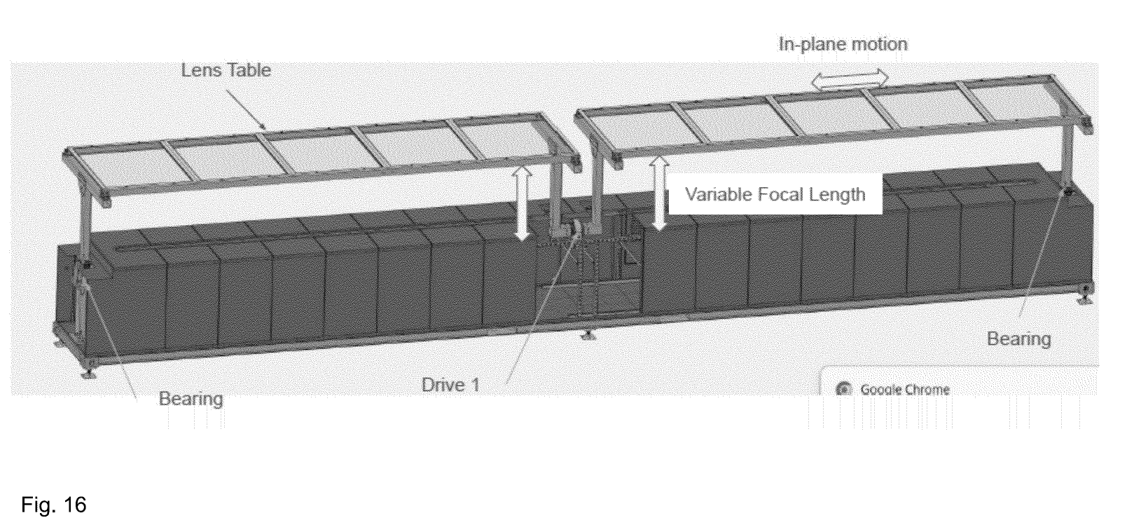

FIG. 16 shows an example embodiment that further provides in-plane or horizontal motion or positional adjustment of the Fresnel lenses 100. Such adjustment can be provided during setup to adjust for the geolocation of the system. Or as shown in FIG. 12, an electronic controller can operate an actuator to provide an automatic adjustment and/or provide instructions to an operate for making a manual adjustment.

All patents and publications cited herein are incorporated by reference as if expressly set forth.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A solar collector comprising:
an array of Fresnel panels mounted to a common frame;
a frame suspension mechanically coupled to the common frame, the frame suspension suspending the array of Fresnel panels above at least one absorbing structure; and
a tracking drive mechanically coupled to the common frame and/or the frame suspension, the tracking drive operable to move the array of Fresnel panels in a single axis to track position of the sun.

2. The solar collector of claim 1 wherein the tracking drive comprises a slewing drive.

3. The solar collector of claim 1 wherein further including an electronic controller connected to control the tracking drive.

4. The solar collector of claim 1 wherein the tracking drive controls the pitch of the array of Fresnel panels.

5. The solar collector of claim 1 wherein the tracking drive controls the tilt orientation of the array of Fresnel panels.

6. The solar collector of claim 1 wherein the at least one absorbing structure is stationary.

7. The solar collector of claim 1 further including a focal length adjustment configured to adjust the focal length of the array of Fresnel panels relative to the at least one absorbing structure.

8. The solar collector of claim 1 further including an in plane adjustment configured to adjust the in place position of the array of Fresnel panels relative to the at least one absorbing structure.
